(19) United States
(12) Patent Application Publication
(10) Pub. No.: US 2012/0012779 A1
(43) Pub. Date: Jan. 19, 2012

(54) TEMPERATURE ADJUSTMENT DEVICE

(75) Inventors: Thomas Foo, Wilmington, DE (US); Edward R. Murphy, Lakeland, TN (US); Dennis A. Redder, Hockessin, DE (US); Mark A. Scialdone, West Grove, PA (US); Mark Brandon Shiflett, Wilmington, DE (US)

(73) Assignee: E.I. DU PONT DE NEMOURS AND COMPANY, Wilmington, DE (US)

(21) Appl. No.: 13/259,277

(22) PCT Filed: Mar. 31, 2010
(86) PCT No.: PCT/US2010/029311

§ 371 Date: Sep. 23, 2011

(51) Int. Cl. C09K 5/04

(52) U.S. Cl. 252/69

(57) ABSTRACT

This invention relates to a temperature adjustment device that executes an absorption cooling or heating cycle in which a lithium halide, typically a lithium bromide, absorbent is used.

This application claims priority under 35 U.S.C. §119(e) from, and claims the benefit of, U.S. Provisional Application No. 61/165,155 (filed Mar. 31, 2009), which is by this reference incorporated in its entirety as a part hereof for all purposes.

### TECHNICAL FIELD

This invention relates to a temperature adjustment device that executes an absorption cooling or heating cycle in which a lithium halide, typically a lithium bromide, absorbent is used.

### BACKGROUND

The absorption cooling and heating cycle is a more-than-100-year-old technique, and is well known from descriptions such as that by Haaf et al in “Refrigeration Technology” (Ullmann's Encyclopedia of Industrial Chemistry, Sixth Edition, Wiley-VCH Verlag GmbH, Weinheim, Germany, Volume 31, pages 269-312). The basic cooling cycle uses a low-temperature liquid refrigerant that converts to a vapor phase (in the evaporator section of a temperature adjustment device), and thereby absorbs heat from an object, spade or medium (such as air or water) to be cooled. The refrigerant vapors are then compressed to a higher pressure by a generator, converted back into a liquid by rejecting heat to the external surroundings (in the condenser section), and then expanded to a low-pressure mixture of liquid and vapor (in the expander section) that goes back to the evaporator section and the cycle is repeated. An absorption system uses heat for compressing refrigerant vapors to a high-pressure.

In a temperature adjustment device of the absorption type, an absorbent, diluted with an absorbed refrigerant, is heated in a generator to vaporize some of the refrigerant. The refrigerant vapor then flows to a condenser where it is condensed to a liquid by heat exchange with an external cooling fluid maintained at a low temperature by a heat sink. The liquefied refrigerant then flows through a valve to an evaporator which vaporizes the refrigerant (usually at low pressure) to produce refrigeration. The vaporized refrigerant then flows to an absorber where it is absorbed by concentrated absorbent supplied from the generator. From the absorber, the diluted absorbent passes to the generator where it is concentrated by heating to vaporize some of the refrigerant, and thus repeat the cycle.

Conventional absorption devices typically employ an aqueous solution of lithium bromide as an absorbent and water as a refrigerant. The operating efficiency of these devices increases with the difference between the highest fluid temperature where the solution is dilute in lithium bromide and water is being vaporized, and the lowest fluid temperature where the solution is very concentrated in lithium bromide and water is being absorbed. Since the high cycle temperature is generally fixed by the application (cooling or heating) to which the device is being put, the efficiency of the cycle can be increased by lowering the low cycle temperature.

As the low cycle temperature is reduced, the concentration of lithium bromide must be increased in order to permit the continued absorption of water vapor. As the salt concentration is increased and the temperature is decreased, a solubility limit is approached. If the solubility limit of lithium bromide in water is exceeded, hydrated salt crystals may form which block the flow circulation in the absorber, rendering it useless. Thus, conventional absorption devices use solutions containing about 60-62% salt, and operate at a minimum fluid temperature of about 4-7° C. in air conditioning applications. For heating applications, the salt concentration may be lowered, to prevent freezing of the solution at temperatures down to −25° C. or lower.

Absorption temperature adjustment devices have many large-scale uses in industrial air-conditioning and refrigeration, as well as heating and temperature boosting. A need thus remains for more efficient devices that maximize the difference between the high and low fluid temperatures at different parts of the cycle.

### SUMMARY

This invention provides for the execution or performance of an absorption cycle by operating or running a temperature adjustment device that is suitable to accomplish heating or cooling in view of the heat rejected and absorbed during the repetition of the cycle.

In one embodiment hereof, this invention provides a temperature adjustment device that executes an absorption cycle, wherein the working fluid comprises an aqueous solution of a lithium halide and an ionic compound; wherein, in the ionic compound, the cations are selected from the group consisting of lithium, sodium, potassium, rubidium, cesium and mixtures thereof; and the anion is selected from among the members of the following groups:

(a) the group consisting of carborates (1-carbadodecaborate(1-), optionally substituted with alkyl or substituted alkyl; carboranes (dicarbadodecaborate(1-) optionally substituted with alkylamine, substituted alkylamine, alkyl or substituted alkyl; [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, and [(CF₃CFHCF₂SO₂)₂N]⁻;

(b) the group consisting of carbonate, glycolate, aminoacetate (glycine), ascorbate, benzoate, catecholate, citrate, dimethylphosphate, fumarate, gallate, glycolate, glyoxylate, iminodiacetate, isobutyrate, kojate (5-hydroxy-2-hydroxymethyl-4-pyrone ion), lactate, levulinate, oxalate, pivalate, propionate, pyruvate, salicylate, succinamate, succinate, tiglate (CH₃CH═C(CH₃)COO⁻), tetrafluoroborate, tetrafluoroethanesulfonate, and tropolonate (2-hydroxy-2,4,6-cycloheptatrien-1-one ion),

(c) the group consisting of anions formed from glycolic, oxalic, malonic, succinic, glutaric, adipic, or maleic acid;

(d) the group consisting of [CH₃CO₂]⁻, [HSO₄]⁻, [CH₃OSO₃]⁻, [C₂H₅OSO₃]⁻, [AlCl₄]⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, SCN⁻; and BR¹R²R³R⁴, and BOR¹OR²OR³OR⁴; wherein R¹, R², R³, and R⁴ are each independently selected from the group consisting of:
(i) H
(ii) halogen
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₃ to C₂₅ unsubstituted heteroaryl having one to three heteroatoms independently selected from the group consisting of O, N, Si and S; and
(vi) C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
   (2) OH,
   (3) NH₂, and
   (4) SH;
   (vii) —(CH₂)ₙSi(CH₂)ₘCH₃, —(CH₂)ₙSi(CH₃)₃, —(CH₂)ₙOSi(CH₃)ₘ, where n is independently 1-4 and m is independently 0-4;
      wherein optionally at least two of R¹, R², R³, R⁴, R⁵, R⁶, R⁷, R⁸, R⁹, and R¹⁰ can together form a cyclic or bicyclic alkanyl or alkenyl group.

(e) the group of anions consisting of those represented by the structure of the following formula:

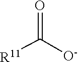

wherein R¹¹ is selected from the group consisting of:
(i) —CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₃ to C₁₀ unsubstituted heteroaryl having one to three heteroatoms independently selected from the group consisting of O, N, Si and S; and
(iv) C₆ to C₁₀ substituted aryl, or C₃ to C₁₀ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,
   (2) OH,
   (3) NH₂, and
   (4) SH; and

(f) the member of the group consisting of the anion represented by the structure of the following formula

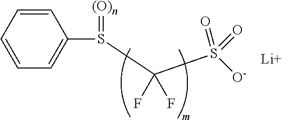

wherein n=0-2 and m=1-2,

In yet another embodiment hereof, this invention provides an aqueous solution of a lithium halide and an ionic compound as described above.

In yet another embodiment hereof, this invention provides a method of adjusting the temperature of an object, medium or a space comprising executing an absorption cycle in a device located adjacent to the object, medium or space, wherein water is absorbed into an aqueous solution of a lithium halide and an ionic compound as described above.

In yet another embodiment hereof, this invention provides, in an aqueous solution of a lithium halide, a method of decreasing either or both of the temperature at which the onset of crystallization in the solution occurs, or the temperature at which the solution freezes, comprising admixing with the solution an additive comprising an ionic compound as described above.

In various other embodiments hereof, the working fluid, composition or aqueous solution, as referred to above, may as desired contain

at least 56 wt % and yet not more than 70 wt % lithium halide,

at least 1 wt % and yet not more than 17 wt % ionic compound, and

at least 13 wt % and yet not more than 43 wt % water;

based on the total weight of all three components together.

### BRIEF DESCRIPTION OF THE DRAWINGS

FIG. 1 is a schematic diagram of the components involved in the execution of a typical absorption cycle.

FIG. 2 is a schematic diagram of the arrangement of components in the type of absorption cycle used to obtain the results of Examples 5 and 6.

FIG. 3 is a plot showing the effect of reduced absorber temperature on cycle efficiency, as measured by improvement in coefficient of performance (COP).

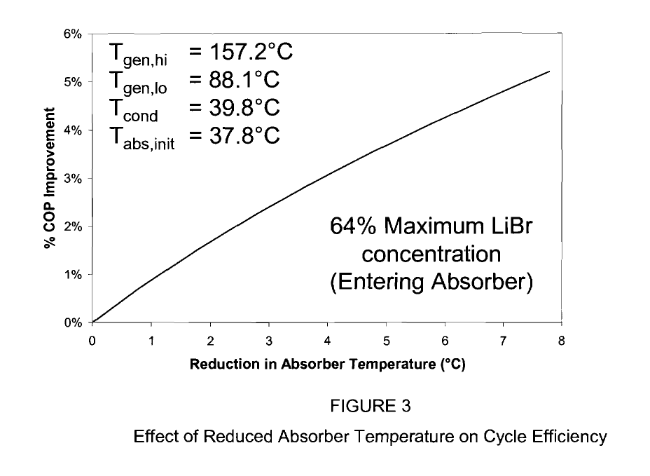

### DETAILED DESCRIPTION

This invention relates to a temperature adjustment device that is based on the use of a refrigerant pair in an absorption cooling and/or heating system, and which thus executes an absorption cycle. This invention also relates to materials to be included in a useful refrigerant pair, and also to a method for temperature adjustment, either cooling or heating, as is obtained by the operation of a temperature adjustment device utilizing refrigerant pairs as described herein. This invention also relates to methods for improving refrigerant pairs suitable for use herein by incorporating those refrigerant pairs into working fluids having advantageous properties.

A refrigerant is a fluidic substance that may be used as a thermal energy transfer vehicle. A refrigerant, when it changes phase from liquid to vapor (evaporates), removes heat from the surroundings; and when it changes phase from vapor to liquid (condenses), adds heat to the surroundings. Although the term refrigerant may carry the connotation of a substance used only for cooling, the term is used herein in the generic sense of a thermal energy transfer vehicle or substance that is applicable for use in a system or device that may be used for cooling and/or heating.

The terms “refrigerant pair” and “refrigerant/absorbent pair” are used interchangeably, and refer to a mixture suitable for use in the execution or operation of an absorption cycle, which requires the presence of both a refrigerant and an absorbent, where the absorbent absorbs the refrigerant. The energy efficiency of the absorption cycle will increase in direct proportion to the extent to which the absorbent has high absorption for the refrigerant (i.e. the refrigerant has high miscibility therewith or the refrigerant is soluble therein to a large extent). An absorbent as used in an absorption heating or cooling cycle is desirably thus also a material that has high solubility for a refrigerant (e.g. water) and also a very high boiling point relative to the refrigerant. As noted elsewhere, the absorbent herein is typically a lithium halide, or an aqueous lithium halide solution, and the refrigerant is typically water.

A working fluid is a composition of a refrigerant pair and one or more additives that are incorporated therein to improve the efficiency with which the refrigerant pair transfers thermal energy as the absorption cycle is executed within a temperature adjustment device.

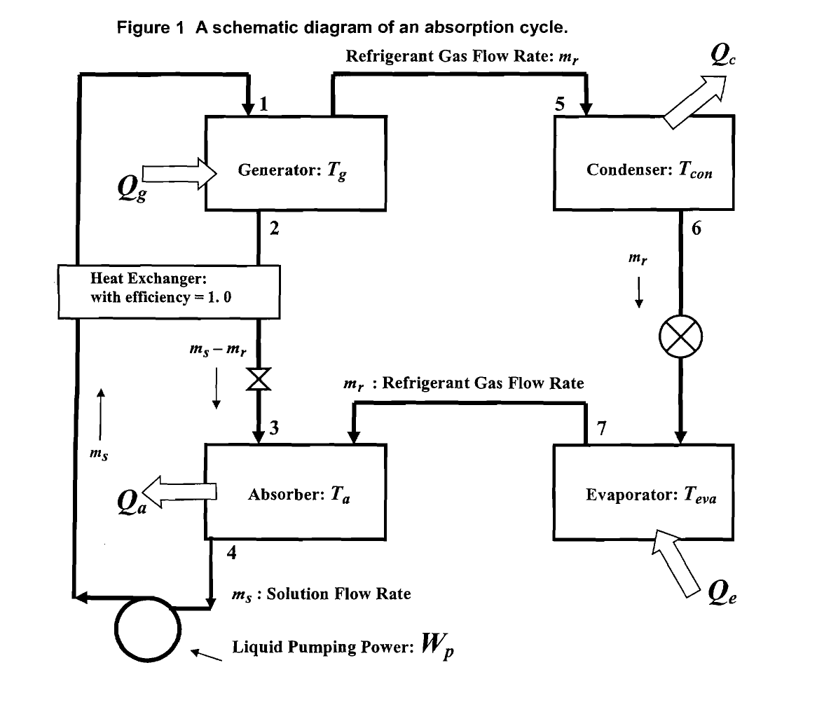

A schematic diagram for a typical absorption cycle, and the components contained in a device by which it may be run, is shown in FIG. 1. The device is composed of condenser and evaporator units with an expansion valve similar to an ordinary vapor compression cycle, but an absorber-generator solution circuit replaces the compressor. The circuit may be composed of an absorber, a generator, a heat exchanger, a pressure control device and a pump for circulating the solution. In some embodiments, the heat released by the absorber upon the absorption of the refrigerant by the absorbent may be used to heat a mixture of refrigerant and absorbent in the generator to separate the refrigerant in vapor form from the absorbent.

As shown in FIG. 1, a typical device for operating an absorption cycle may include components such as an absorber-generator solution circuit as shown on the left side of the drawing, which by the outflow and inflow of heat increases the pressure of refrigerant vapor as a compressor does mechanically, where the circuit may be composed of an absorber, a generator, a heat exchanger, a pressure control device and a pump for circulating the solution. The apparatus also is composed of condenser and evaporator units with an expansion valve, as shown on the right side of the drawing.

In the apparatus as shown in FIG. 1, mixture of a refrigerant and an absorbent is formed in the absorber; the mixture is passed to a generator where the mixture is heated to separate refrigerant, in vapor form, from the absorbent, and the pressure of the refrigerant vapor is increased; the refrigerant vapor is passed to a condenser where the vapor is condensed under pressure to a liquid; the liquid refrigerant is passed to an expansion device where the pressure of the liquid refrigerant is reduced to form a mixture of liquid and vapor refrigerant; the mixture of liquid and vapor refrigerant is passed to an evaporator where the remaining liquid is evaporated to form refrigerant vapor; the refrigerant vapor leaving the evaporator is passed to the absorber to repeat step (a) and re-form a mixture of the refrigerant vapor and the absorbent.

An absorption cycle, and systems in which it may be run, are discussed further in Application Guide for Absorption Cooling/Refrigeration Using Recovered Heat [Dorgan et al (American Society of Heating, Refrigeration and Air Conditioning Engineers, Inc., 1995, Atlanta Ga., Chapter 5)], and in Van Nostrand's Scientific Encyclopedia, “Heat Pump”, 2005, John Wiley & Sons, Inc.

A device as shown in FIG. 1, and the device as disclosed herein, is capable of executing an absorption cycle using a lithium halide as the absorbent and water as the refrigerant. Such a device is also capable of executing any one or more of the methods as described herein. Yet another embodiment of this invention is thus a device substantially as shown or described in FIG. 1.

In one embodiment, this invention thus provides a device for heating an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser, located in proximity to the object, medium or space to be heated, that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator that receives the mixture of liquid and vapor refrigerant that passes through the pressure reduction device to evaporate the remaining liquid to form refrigerant vapor; and (f) means to pass the refrigerant vapor leaving the evaporator to the absorber.

In another embodiment, this invention also provides a device for cooling an object, medium or space that includes (a) an absorber that forms a mixture of a refrigerant and an absorbent; (b) a generator that receives the mixture from the absorber and heats the mixture to separate refrigerant, in vapor form, from the absorbent, and increases the pressure of the refrigerant vapor; (c) a condenser that receives the vapor from the generator and condenses the vapor under pressure to a liquid; (d) a pressure reduction device through which the liquid refrigerant leaving the condenser passes to reduce the pressure of the liquid to form a mixture of liquid and vapor refrigerant; (e) an evaporator, located in proximity to the object, medium or space to be cooled, that receives the mixture of liquid and vapor refrigerant that passes through the pressure reduction device to evaporate the remaining liquid to form refrigerant vapor; and (0 means to pass the refrigerant vapor leaving the evaporator to the absorber.

A device of this invention may be deployed for use in, or fabricated or operated as, a refrigerator, a freezer, an ice machine, an air conditioner, an industrial cooling system, a heater or heat pump. Each of these instruments may be situated in a residential, commercial or industrial setting, or may be incorporated into a mobilized device such as a car, truck, bus, train, airplane, or other device for transportation, or may be incorporated into a piece of equipment such as a medical instrument.

In another embodiment, this invention also provides a method for heating an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid in proximity to the object, medium or space to be heated; (d) reducing the pressure of the liquid refrigerant, and evaporating the refrigerant to form refrigerant vapor; and (e) repeating step (a) to re-absorb, with the absorbent, the refrigerant vapor.

In another embodiment, this invention also provides a method for cooling an object, medium or a space comprising (a) absorbing refrigerant vapor with an absorbent to form a mixture; (b) heating the mixture to separate refrigerant, in vapor form, from the absorbent and increase the pressure of the refrigerant vapor; (c) condensing the refrigerant vapor under pressure to a liquid; (d) reducing the pressure of the liquid refrigerant, and evaporating the refrigerant, in proximity to the object, medium or space to be cooled, to form refrigerant vapor; and (e) repeating step (a) to re-absorb, with the absorbent, the refrigerant vapor.

In another embodiment, this invention also provides a method for heating an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser in proximity to the object, medium or space to be heated where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator where the remaining liquid is evaporated to form refrigerant vapor; and (0 passing the refrigerant vapor leaving the evaporator to the absorber to repeat step (a) and re-form a mixture of the refrigerant vapor and the absorbent.

In another embodiment, this invention also provides a method for cooling an object, medium or a space in an apparatus that executes an absorption cycle by (a) forming in an absorber a mixture of a refrigerant and an absorbent; (b) passing the mixture to a generator where the mixture is heated to separate refrigerant, in vapor form, from the absorbent, and the pressure of the refrigerant vapor is increased; (c) passing the refrigerant vapor to a condenser where the vapor is condensed under pressure to a liquid; (d) passing the liquid refrigerant to an expansion device where the pressure of the liquid refrigerant is reduced to form a mixture of liquid and vapor refrigerant; (e) passing the mixture of liquid and vapor refrigerant to an evaporator in proximity to the object, medium or space to be cooled where the remaining liquid is evaporated to form refrigerant vapor; and (f) passing the refrigerant vapor leaving the evaporator to the absorber to repeat step (a) and re-form a mixture of the refrigerant vapor and the absorbent.

In any device or method as described above, the absorbent, refrigerant and/or working fluid may be any one or more of those described herein, and the absorbent separated from refrigerant in step (b) may be recirculated for use in a later step.

In the inventions hereof, the refrigerant pair is typically composed of at least about 40 wt %, or at least about 50 wt %, water as the refrigerant; and about 45 wt % to about 60 wt %, or about 50 wt % to about 60 wt %, lithium halide as the absorbent. Lithium bromide and/or lithium chloride, more typically lithium bromide, are suitable lithium halides for use as the absorbent. The amount of lithium halide present in the system must be sufficient to effectively absorb the refrigerant at the lowest cycle temperature.

The formation of an improved working fluid by the incorporation of an additive therein along with the refrigerant pair reduces crystallization of the lithium halide, reduces the number of equipment failures due to crystallization, and allows the system to operate at lower temperatures and/or higher lithium concentrations, which increases the overall efficiency of the system. The absorption system hereof, in which the improved working fluid hereof is used, is thermodynamically stable against crystallization of the lithium halide down to a temperature of about 40° C. or below, or 20° C. or below, −10° C. or below, or −20° C. or below.

As a result, there is provided, in one embodiment of this invention, a temperature adjustment device that executes an absorption cycle, wherein the working fluid, particularly the working fluid when it is transferred from the generator to the absorber, comprises an aqueous solution of a lithium halide, preferably lithium bromide, and cesium formate that comprises

at least 56 wt %, at least 58 wt %, at least 60 wt %, or at least 62 wt %, and yet not more than 70 wt %, or not more than 68 wt %, or not more than 66 wt %, or not more than 64 wt % lithium halide,

at least 1 wt %, at least 5 wt %, at least 7 wt %, or at least 9 wt %, and yet not more than 17 wt %, or not more than 15 wt %, or not more than 13 wt %, or not more than 11 wt % cesium formate, and

at least 13 wt %, at least 17 wt %, at least 21 wt %, or at least 25 wt %, and yet not more than 43 wt %, or not more than 37 wt %, or not more than 33 wt %, or not more than 29 wt % water;

based on the total weight of all three components together.

In another embodiment hereof, this invention provides an aqueous solution of a lithium halide and cesium formate that comprises lithium halide, cesium formate and water in the ranges of the respective components as set forth above.

In yet another embodiment hereof, this invention provides a method of adjusting the temperature of an object, medium or a space comprising executing an absorption cycle in a device located adjacent to the object, medium or space, wherein water is absorbed into an aqueous solution of a lithium halide and cesium formate that comprises lithium halide, cesium formate and water in the ranges of the respective components as set forth above.

In yet another embodiment hereof, this invention provides, in an aqueous solution of a lithium halide, a method of decreasing either or both of the temperature at which the onset of crystallization in the solution occurs, or the temperature at which the solution freezes, at a pressure for example of 100 kPa, comprising admixing with the solution an additive comprising a cesium formate such that the solution will thereupon comprise lithium halide, cesium formate and water in the ranges of the respective components as set forth above.

In yet another embodiment hereof, this invention provides a temperature adjustment device that executes an absorption cycle, wherein the working fluid, particularly the working fluid when it is transferred from the generator to the absorber, comprises an aqueous solution of ions that comprises

at least 56 wt %, at least 58 wt %, at least 60 wt %, or at least 62 wt %, and yet not more than 70 wt %, or not more than 68 wt %, or not more than 66 wt %, or not more than 64 wt % lithium cations,

at least 56 wt %, at least 58 wt %, at least 60 wt %, or at least 62 wt %, and yet not more than 70 wt %, or not more than 68 wt %, or not more than 66 wt %, or not more than 64 wt % halide anions,

at least 1 wt %, at least 5 wt %, at least 7 wt %, or at least 9 wt %, and yet not more than 17 wt %, or not more than 15 wt %, or not more than 13 wt %, or not more than 11 wt % cesium cations, and

at least 1 wt %, at least 5 wt %, at least 7 wt %, or at least 9 wt %, and yet not more than 17 wt %, or not more than 15 wt %, or not more than 13 wt %, or not more than 11 wt % formate anions, and

at least 13 wt %, at least 17 wt %, at least 21 wt %, or at least 25 wt %, and yet not more than 43 wt %, or not more than 37 wt %, or not more than 33 wt %, or not more than 29 wt % water;

based on the total weight of all three components together.

In yet another embodiment hereof, this invention provides an aqueous solution of ions that comprises lithium cations, cesium cations, halide anions, formate anions and water in the ranges of the respective components as set forth above.

In yet another embodiment hereof, this invention provides a method of adjusting the temperature of an object, medium or a space comprising executing an absorption cycle in a device located adjacent to the object, medium or space, wherein water is absorbed into an aqueous solution of ions that comprises lithium cations, cesium cations, halide anions, formate anions and water in the ranges of the respective components as set forth above.

In yet another embodiment hereof, this invention provides a temperature adjustment device that executes an absorption cycle, wherein the working fluid comprises an aqueous solution of a lithium halide and a metal formate, wherein the metal is selected from the group consisting of lithium, sodium and/or rubidium.

In yet another embodiment hereof, this invention provides an aqueous solution of a lithium halide and a metal formate, wherein the metal is selected from the group consisting of lithium, sodium and/or rubidium.

In yet another embodiment hereof, this invention provides a method of adjusting the temperature of an object, medium or a space comprising executing an absorption cycle in a device located adjacent to the object, medium or space, wherein water is absorbed into an aqueous solution of a lithium halide and a metal formate, wherein the metal is selected from the group consisting of lithium, sodium and/or rubidium.

In yet another embodiment hereof, this invention provides, in an aqueous solution of a lithium halide, a method of decreasing either or both of the temperature at which the onset of crystallization in the solution occurs, or the temperature at which the solution freezes, at a pressure for example of 100 kPa, comprising admixing with the solution an additive comprising a metal formate,

wherein the metal is selected from the group consisting of lithium, sodium and/or rubidium.

In various other embodiments hereof, the working fluid, composition or aqueous solution, as referred to above, may contain

at least 56 wt %, at least 58 wt %, at least 60 wt %, or at least 62 wt %, and yet not more than 70 wt %, or not more than 68 wt %, or not more than 66 wt %, or not more than 64 wt % lithium halide,

at least 1 wt %, at least 5 wt %, at least 7 wt %, or at least 9 wt %, and yet not more than 17 wt %, or not more than 15 wt %, or not more than 13 wt %, or not more than 11 wt % metal formate, and

at least 13 wt %, at least 17 wt %, at least 21 wt %, or at least 25 wt %, and yet not more than 43 wt %, or not more than 37 wt %, or not more than 33 wt %, or not more than 29 wt % water;

based on the total weight of all three components together.

In yet another embodiment hereof, this invention provides a temperature adjustment device that executes an absorption cycle, wherein the working fluid, particularly when transferred from the generator to the absorber, comprises an aqueous solution of a lithium halide and an ionic compound; wherein, in the ionic compound, the cations are selected from the group consisting of lithium, sodium, potassium, rubidium, cesium and mixtures thereof; and the anion is selected from among the members of the following groups:

(a) the group consisting of carborates (1-carbadodecaborate(1-), optionally substituted with alkyl or substituted alkyl; carboranes (dicarbadodecaborate(1-) optionally substituted with alkylamine, substituted alkylamine, alkyl or substituted alkyl; [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂₁CF₂OCF₂CF₂SO₃]⁻, [CF₃CF₂OCF₂CF₂SO₃]⁻, [(CF₂HCF₂SO₂)₂N]⁻, and [(CF₃CFHCF₂SO₂)₂N]⁻;

(b) the group consisting of carbonate, glycolate, aminoacetate (glycine), ascorbate, benzoate, catecholate, citrate, dimethylphosphate, fumarate, gallate, glycolate, glyoxylate, iminodiacetate, isobutyrate, kojate (5-hydroxy-2-hydroxymethyl-4-pyrone ion), lactate, levulinate, oxalate, pivalate, propionate, pyruvate, salicylate, succinamate, succinate, tiglate (CH₃CH═C(CH₃)COO⁻), tetrafluoroborate, tetrafluoroethanesulfonate, and tropolonate (2-hydroxy-2,4,6-cycloheptatrien-1-one ion),

(c) the group consisting of anions formed from glycolic, oxalic, malonic, succinic, glutaric, adipic, or maleic acid;

(d) the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, SCN⁻; and BR¹R²R³R⁴, and BOR¹OR²OR³OR⁴; wherein R¹, R², R³, and R⁴ are each independently selected from the group consisting of:
(vii) H
(viii) halogen
(ix)-CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₀ unsubstituted aryl, or C₃ to C₂₅ unsubstituted heteroaryl having one to three heteroatoms independently selected from the group consisting of O, N, Si and S; and
(xii) C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
   (5) OH,
   (6) NH₂, and
   (7) SH;
(vii) —(CH₂)ₙSi(CH₂)ₘCH₃, —(CH₂)ₙSi(CH₃)₃, —(CH₂)ₙOSi(CH₃)ₘ, where n is independently 1-4 and m is independently 0-4;
   wherein optionally at least two of R¹, R², R³, R⁴, R⁵, R⁶, R⁷, R⁸, R⁹, and R¹⁰ can together form a cyclic or bicyclic alkanyl or alkenyl group.

(e) the group of anions consisting of those represented by the structure of the following formula:

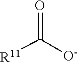

wherein R¹¹ is selected from the group consisting of:
(v) —CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(vi) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(vii) C₆ to C₁₀ unsubstituted aryl, or C₃ to C₁₀ unsubstituted heteroaryl having one to three heteroatoms independently selected from the group consisting of O, N, Si and S; and
(viii) C₆ to C₁₀ substituted aryl, or C₃ to C₁₀ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,
   (5) OH,
   (6) NH₂, and
   (7) SH; and

(f) the member of the group consisting of the anion represented by the structure of the following formula

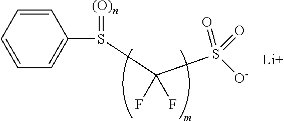

wherein n=0-2 and m=1-2,

In general, the anion may be an organic anion, i.e. an anion having at least one carbon atom, and can be aliphatic or aromatic.

In yet another embodiment hereof, this invention provides an aqueous solution of a lithium halide and an ionic compound as described above.

In yet another embodiment hereof, this invention provides a method of adjusting the temperature of an object, medium or a space comprising executing an absorption cycle in a device located adjacent to the object, medium or space, wherein water is absorbed into an aqueous solution of a lithium halide and an ionic compound as described above.

In yet another embodiment hereof, this invention provides, in an aqueous solution of a lithium halide, a method of decreasing either or both of the temperature at which the onset of crystallization in the solution occurs, or the temperature at which the solution freezes, at a pressure for example of 100 kPa, comprising admixing with the solution an additive comprising an ionic compound as described above.

In general, when the refrigerant is water or an aqueous mixture, it would be expected to be more miscible with or soluble in absorbents that are hydrophilic to some extent, and absorbents comprising anions having at least one acetate or sulfate group, would thus be particularly desirable choices for use in various embodiments of this invention.

In various other embodiments hereof, the working fluid, composition or aqueous solution, as referred to above, may contain

at least 56 wt %, at least 58 wt %, at least 60 wt %, or at least 62 wt %, and yet not more than 70 wt %, or not more than 68 wt %, or not more than 66 wt %, or not more than 64 wt % lithium halide,

at least 1 wt %, at least 5 wt %, at least 7 wt %, or at least 9 wt %, and yet not more than 17 wt %, or not more than 15 wt %, or not more than 13 wt %, or not more than 11, wt % ionic compound, and

at least 13 wt %, at least 17 wt %, at least 21 wt %, or at least 25 wt %, and yet not more than 43 wt %, or not more than 37 wt %, or not more than 33 wt %, or not more than 29 wt % water;

based on the total weight of all three components together.

In various embodiments of this invention, an ionic compound formed by selecting any of the individual anions described or disclosed above, may be used as an absorbent in an absorption heating or cooling cycle. Correspondingly, in yet other embodiments, a subgroup of ionic compounds formed by selecting a subgroup of any size of anions, taken from the total group of anions described and disclosed herein in all the various different combinations of the individual members of that total group, may be used as an absorbent. In forming an ionic compound, or a subgroup of ionic compounds, by making selections as aforesaid, the ionic compound or subgroup will be used in the absence of the members of the group of cations and/or anions that are omitted from the total group thereof to make the selection, and, if desirable, the selection may thus be made in terms of the members of the total group that are omitted from use rather than the members of the group that are included for use.

The following examples are presented to illustrate the advantages of the present invention and to assist one of ordinary skill in making and using the same, and describe methods of preparing particular ionic compounds suitable for use herein. These examples are not intended in any way otherwise to limit the scope of the disclosure.

### Example 1

A 500 mL solution of 65% by weight lithium bromide was prepared by dissolving the salt in deionized water by heating to 60° C. to form a liquid solution. Using this solution a series of 10 mL samples was created by adding quantities of cesium formate. After finding the sample uniformly dissolved, each sample was observed at 60° C., 20° C. and −20° C. to determine the sample phase. Table 1 below lists for each sample the weight percentage of lithium bromide, cesium formate and water components, the total salt weight percentage, and the observed phase at 60° C., 20° C. and −20° C.

TABLE 1

| | Cs | | | | | | | |
|---|---|---|---|---|---|---|---|---|
| | for- | | Cs | | | | | |
| | mate/ | | for- | | Total | | | |
| Sam- | LiBr | LiBr | mate | Water | Salt | | | |
| ple | ratio | wt % | wt % | wt % | wt % | 60° C. | 20° C. | −20° C. |
| 1 | 0 | 65.0 | 0.0 | 35.0 | 65 | Liquid | Solid | Solid |
| 2 | 5 | 63.0 | 3.1 | 33.9 | 66 | Liquid | Solid | Solid |
| 3 | 10 | 61.0 | 6.1 | 32.9 | 67 | Liquid | Liquid | Solid |
| 4 | 20 | 57.5 | 11.5 | 31.0 | 69 | Liquid | Liquid | Liquid |
| 5 | 30 | 54.4 | 16.3 | 29.3 | 71 | Liquid | Solid | Solid |
| 6 | 40 | 51.6 | 20.6 | 27.8 | 72 | Solid | Solid | Solid |

### Example 2

A series of 10 mL samples was created by dissolving lithium bromide and a second salt in deionized water by heating to 60° C. to form a liquid solution. After finding the sample uniformly dissolved, each sample was observed at 60° C., 20° C. and −20° C. to determine the sample phase. Each sample contained 57.5% by weight lithium bromide. Table 2 below lists for each sample the: weight percentage and identity of the second salt component, the total water and salt weight percentages, and the observed phase at 60° C., 20° C. and −20° C. Although all salts are very similar in structure, other salts did not show the similar lowering of crystallization temperature compared to cesium formate.

TABLE 2

| | Water | Total Salt | | | |
|---|---|---|---|---|---|
| 57.5 wt % LiBr with: | wt % | wt % | 60° C. | 20° C. | −20° C. |
| 11.5 wt % potassium | 31 | 69 | Solid | Solid | Solid |
| formate | | | | | |
| 11.5 wt % rubidium | 31 | 69 | Solid | Solid | Solid |
| formate | | | | | |
| 11.5 wt % lithium | 31 | 69 | Solid | Solid | Solid |
| formate | | | | | |
| 11.5 wt % cesium | 31 | 69 | Liquid | Liquid | Liquid |
| formate | | | | | |
| 11.5 wt % cesium | 31 | 69 | Solid | Solid | Solid |
| acetate | | | | | |
| 11.5 wt % cesium | 31 | 69 | Liquid | Solid | Solid |
| glycolate | | | | | |
| 11.5 wt % cesium | 31 | 69 | Solid | Solid | Solid |
| bromide | | | | | |
| 11.5 wt % zinc bromide | 31 | 69 | Solid | Solid | Solid |

### Example 3

Individual solutions of lithium bromide and cesium formate with deionized water were prepared by weighing the components into a 40 mL vial and dissolving the salts at 60° C. After finding the sample uniformly dissolved, each sample was observed at 60° C., 40° C., 20° C., 10° C., 0° C. and −20° C. to determine the sample phase. Table 3 below lists for each sample the: weight percentage of lithium bromide, cesium formate and water components, the total salt weight percentage, and the observed phase.

TABLE 3

| | % | % Cs | % | % | | | | | | |
|---|---|---|---|---|---|---|---|---|---|---|
| Sample | LiBr | Formate | Water | Salt | 60° C. | 40° C. | 20° C. | 10° C. | 0° C. | −20° C. |
| 0% Cs formate | 65.00 | 0.00 | 35.00 | 65.00 | Liquid | Solid | Solid | Solid | Solid | Solid |
| 2.5% Cs formate | 62.50 | 2.50 | 35.00 | 65.00 | Liquid | Liquid | Solid | Solid | Solid | Solid |
| 5% Cs formate | 60.00 | 5.00 | 35.00 | 65.00 | Liquid | Liquid | Liquid | Liquid | Solid | Solid |
| 7.5% Cs formate | 57.50 | 7.50 | 35.00 | 65.0 | Liquid | Liquid | Liquid | Liquid | Liquid | Solid |
| 10% Cs formate | 55.00 | 10.00 | 35.00 | 65.00 | Liquid | Liquid | Liquid | Liquid | Liquid | Liquid |
| 15% Cs formate | 50.00 | 15.00 | 35.00 | 65.00 | Liquid | Liquid | Liquid | Liquid | Solid | Solid |

### Example 4

Individual solutions of lithium bromide, cesium formate, and cesium bromide with deionized water were prepared by weighing the components into a 40 mL vial and dissolving the salts. The salt solutions were then exposed to a humidity chamber set at 8.4 mbar and 40° C., a typical condition of operation for the absorber in an absorption chiller. The samples were allowed to equilibrate for 36 hours and the samples were reweighed to determine the water mass loss or mass gain. Table 4 provides the findings for sixteen samples. Sample 13 contains only LiBr and initially contained about 38.87 wt % water and gained 7.47 wt % water at 8.4 mbar and 40° C. Sample 9 contained 0.9 mole fraction LiBr and 0.1 mole fraction lithium formate with an initial water content of about 33.25 wt %. The sample gained 10.19 wt % water at 8.4 mbar and 40° C. The higher the water absorption at the absorber condition (8.4 mbar and 40° C.), the higher the cooling capacity for an absorption chiller.

TABLE 4

| | | | | | Wt % | | | |
|---|---|---|---|---|---|---|---|---|
| | Mole fraction | | | | Initial | Water | % | |
| | | Li | Cs | | water | content at | Change | Liquid |
| | | for- | for- | | con- | 8.4 mbar | in water | contain |
| No. | LiBr | mate | mate | CsBr | tent | and 40° C. | content | solids* |
| 1 | 0.700 | 0.300 | 0.000 | 0.000 | 55.08 | 26.78 | −28.30 | S |
| 2 | 0.667 | 0.242 | 0.058 | 0.033 | 50.84 | 22.69 | −28.15 | S |
| 3 | 0.571 | 0.262 | 0.038 | 0.129 | 46.88 | 17.97 | −28.90 | S |
| 4 | 0.500 | 0.269 | 0.031 | 0.200 | 44.49 | 15.88 | −28.61 | S |
| 5 | 0.800 | 0.200 | 0.000 | 0.000 | 45.12 | 32.87 | −12.25 | L |
| 6 | 0.800 | 0.109 | 0.091 | 0.000 | 43.34 | 25.38 | −17.96 | S |
| 7 | 0.667 | 0.167 | 0.033 | 0.133 | 44.53 | 24.73 | −19.80 | S |
| 8 | 0.571 | 0.198 | 0.002 | 0.229 | 43.73 | 19.11 | −24.62 | S |
| 9 | 0.900 | 0.100 | 0.000 | 0.000 | 33.25 | 43.43 | 10.19 | L |
| 10 | 0.809 | 0.100 | 0.000 | 0.091 | 32.05 | 36.66 | 4.61 | L |
| 11 | 0.733 | 0.100 | 0.000 | 0.167 | 41.22 | 29.41 | −11.81 | S |
| 12 | 0.669 | 0.100 | 0.000 | 0.231 | 45.06 | 23.29 | −21.77 | S |
| 13 | 1.000 | 0.000 | 0.000 | 0.000 | 38.87 | 46.34 | 7.47 | L |
| 14 | 0.909 | 0.000 | 0.000 | 0.091 | 33.37 | 39.87 | 6.49 | L |
| 15 | 0.833 | 0.000 | 0.000 | 0.167 | 30.77 | 35.19 | 4.43 | L |
| 16 | 0.769 | 0.000 | 0.000 | 0.231 | 44.53 | 26.95 | −17.59 | S |

*S: Solid crystals observed in salt solution L: No solid crystals observed in salt solution

In Control A and Examples 5 and 6, the thermodynamic cycle calculations were performed using water stream enthalpies calculated by Lemmon et al, “NIST Reference Fluid Thermodynamic and Transport Properties—REFPROP Version 7.0” [U.S. Department of Commerce Tech. Admin., NIST Standard Reference Data Program (Gaithersburg, Md. 20899)]. The brine solution enthalpies were calculated using “Sorption Systems Consortium (SSC) Software”, Herold, K. E. (www.glue.umd.edu/˜herold/sscmain/), Center for Environmental Energy Engineering, Univ. of Maryland.

### Control A

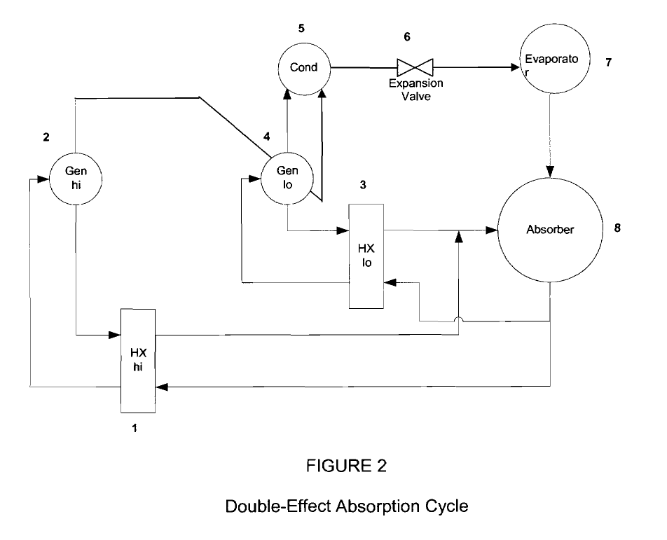

A double effect absorption cycle with an absorber that contacts a solution of lithium bromide in water with 0.8 kPa water vapor at 38° C. produces a solution at an equilibrium concentration of 57% salt and 43% water. The salt used for this cycle was lithium bromide. Referring to FIG. 2, this solution was split such that 42% of the solution passes through a heat exchanger 1 into a high pressure generator 2 and the remaining 58% of the solution was passed through a separate heat exchanger 3 into a low pressure generator 4. The high pressure generator 2 was maintained at 80.4 kPa, where the solution was heated to 157° C. and concentrated to 64 wt % salt in 36 wt % water. The low pressure generator 4 was maintained at 7.3 kPa where condensing steam from the high pressure generator was used to heat the low pressure solution to 88° C. thereby concentrating the solution to 62 wt % salt and 38 wt % water. The water released from the high and low pressure generators was combined and condensed in the condenser 5 at 6.6 kPa and 40° C. This liquid was flashed down through the expansion valve 6 to 0.8 kPa to deliver cooling in the evaporator 7 at 4° C. This water vapor was delivered back to the absorber 8 where it contacts the combined salt solutions to complete the cycle. With both high and low pressure heat exchangers operating with a minimum approach temperature of 5° C. this cycle produced 1.33 kW of cooling for every kW of heat input to the high pressure generator (COP=1.33) and required a 62 kg/hr solution flow rate to provide 1 ton of cooling.

### Example 5

A double effect absorption cycle with an absorber that contacts a solution of cesium formate and lithium bromide in water with 0.8 kPa water vapor at 35° C. produces a solution at an equilibrium concentration of 56% salt and 44% water. The salt was a 5:1 molar mixture of Lithium Bromide and Cesium Formate such that the crystallization of the aqueous solution was reduced by 3° C. The equipment and operating conditions for the condenser, evaporator, high and low pressure generators and high and low pressure heat exchangers were the same as described in Example 6. This cycle produced 1.36 kW of cooling for every kW of heat input to the high pressure generator (COP=1.36) and required a 49 kg/hr solution flow rate to provide 1 ton of cooling.

### Example 6

A double effect absorption cycle with an absorber that contacts a solution of cesium formate and lithium bromide in water with 0.8 kPa water vapor at 30° C. produced a solution at an equilibrium concentration of 53% salt and 47% water. The salt was a 3:1 molar mixture of Lithium Bromide and Cesium Formate such that the crystallization of the aqueous solution was reduced by 8° C. The equipment and operating conditions for the condenser, evaporator, high and low pressure generators and high and low pressure heat exchangers were the same as described in Example 5. This cycle produced 1.40 kW of cooling for every kW of heat input to the high pressure generator (COP=1.4) and required a 34 kg/hr solution flow rate to provide 1 ton of cooling.

FIG. 2 shows the estimated improvement in the COP of a double-effect absorption chiller as a result of the crystallization suppression additive allowing a lower absorber operating temperature. The COP improvement demonstrated in Examples 5 and 6 relative to the base case in Control A are specific points on the curve.

In yet another embodiment hereof, this invention provides, a temperature adjustment device that executes an absorption cycle, wherein the working fluid, particularly when it is transferred from the generator to the absorber, comprises an aqueous solution of a lithium halide and an ionic compound; wherein, in the ionic compound, the cation(s) are selected from the group consisting of lithium, sodium, potassium, rubidium, cesium and mixtures thereof; and the anion is derived from removal of one or more protons (e.g. 2, 3 or 4 protons) from an acid selected from the group consisting of 2-phosphonoacetic acid, ethylenediamine tetramethyl phosphonic acid, etidronic acid, phosphono methylimino diacetic acid, diethylenetriamine penta(methylene phosphonic acid), and 2-phosphono-1,2,4-butane tricarboxylic acid.

In yet another embodiment hereof, this invention provides, an aqueous solution of a lithium halide and an ionic compound; wherein, in the ionic compound, the cations) are selected from the group consisting of lithium, sodium, potassium, rubidium, cesium and mixtures thereof; and the anion is derived from removal of one or more protons (e.g. 2, 3 or 4 protons) from an acid selected from the group consisting of 2-phosphonoacetic acid, ethylenediamine tetramethyl phosphonic acid, etidronic acid, phosphono methylimino diacetic acid, diethylenetriamine penta(methylene phosphonic acid), and 2-phosphono-1,2,4-butane tricarboxylic acid.

In yet another embodiment hereof, this invention provides, a method of adjusting the temperature of an object, medium or a space comprising executing an absorption cycle in a device located adjacent to the object, medium or space, wherein water is absorbed into an aqueous solution of a lithium halide and an ionic compound; wherein, in the ionic compound, the cation(s) are selected from the group consisting of lithium, sodium, potassium, rubidium, cesium and mixtures thereof; and the anion is derived from removal of one or more protons (e.g. 2, 3 or 4 protons) from an acid selected from the group consisting of 2-phosphonoacetic acid, ethylenediamine tetramethyl phosphonic acid, etidronic acid, phosphono methylimino diacetic acid, diethylenetriamine penta(methylene phosphonic acid), and 2-phosphono-1,2,4-butane tricarboxylic acid.

In yet another embodiment hereof, this invention provides, in an aqueous solution of a lithium halide, a method of decreasing either or both of the temperature at which the onset of crystallization in the solution occurs, or the temperature at which the solution freezes, at a pressure for example of 100 kPa, comprising admixing with the solution an additive comprising an ionic compound that comprises one or more cations selected from the group consisting of lithium, sodium, potassium, rubidium, cesium and mixtures thereof; and an anion that is derived from removal of one or more protons (e.g. 2, 3 or 4 protons) from an acid selected from the group consisting of 2-phosphonoacetic acid, ethylenediamine tetramethyl phosphonic acid, etidronic acid, phosphono methylimino diacetic acid, diethylenetriamine penta(methylene phosphonic acid), and 2-phosphono-1,2,4-butane tricarboxylic acid.

In various other embodiments hereof, the working fluid, composition or aqueous solution, as referred to above, may contain

at least 56 wt %, at least 58 wt %, at least 60 wt %, or at least 62 wt %, and yet not more than 0.70 wt %, or not more than 68 wt %, or not more than 66 wt %, or not more than 64 wt % lithium halide,

at least 1 wt %, at least 5 wt %, at least 7 wt %, or at least 9 wt %, and yet not more than 17 wt %, or not more than 15 wt %, or not more than 13 wt %, or not more than 11 wt % ionic compound, and

at least 13 wt %, at least 17 wt %, at least 21 wt %, or at least 25 wt %, and yet not more than 43 wt %, or not more than 37 wt %, or not more than 33 wt %, or not more than 29 wt % water;

based on the total weight of all three components together.

The following examples are presented to illustrate the advantages of the present invention and to assist one of ordinary skill in making and using the same, and describe methods of preparing particular ionic compounds suitable for use herein. These examples are not intended in any way otherwise to limit the scope of the disclosure.

### General Preparation:

Cesium carbonate (99.9% Janssen or 99.95% Aldrich) was dissolved in DI water and treated with one of the acids described below at room temperature with stirring. Gas evolution (CO₂) was observed, and the mixture was stirred until completely homogeneous. Water was removed under reduced pressure, and the product obtained was a dry solid. The material was tested for LiBr crystallization temperature depression without further purification or characterization.

### Structures of Phosphonic Acids Used:

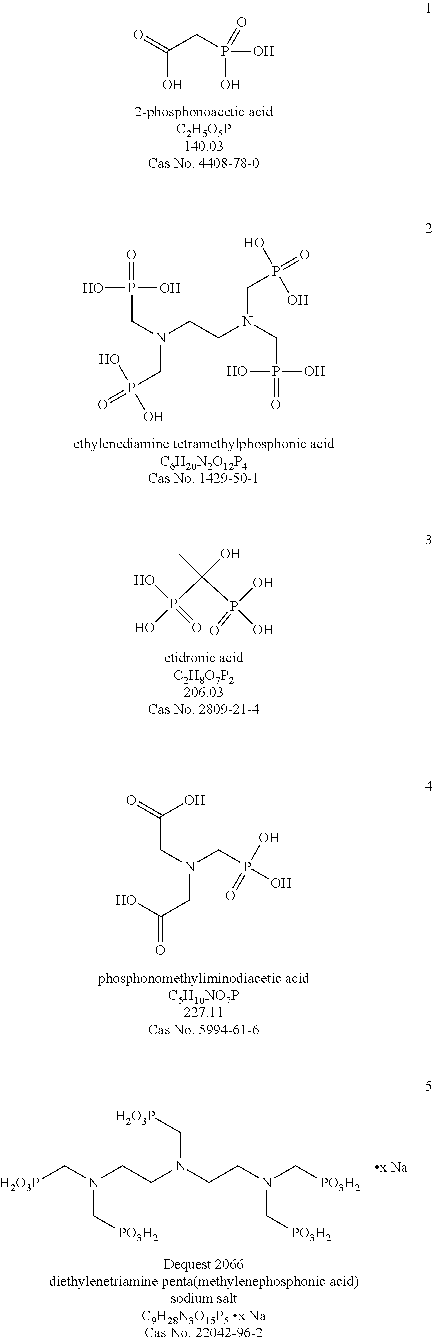

### Commercial Sources of Acids:

| | | | Concentration/ |
|---|---|---|---|
| Phosphonate | Vendor | Components | Purity |
| 2-phosphonoacetic acid | Aldrich | — | 98% |
| ethylenediaminetetramethyl- | TCI | — | 98% |
| phosphonic acid | | | |
| Turpinal SL | Thermphos | etidronic acid | 58%-61% |
| | | phosphonic acid | 2% |
| | | water | 37% |
| Turpinal 4NL | Thermphos | tetrasodium etidronate | 29%-31% |
| | | disodium phosphonate | 2% |
| | | water | 67% |
| phosphonomethyliminodiacetic acid | Aldrich | — | 95% |
| Dequest 2066 | Thermphos | diethylenetriaminepenta | 24%-26% |
| | | (methylenephosphonic | |
| | | acid) sodium salt | |
| | | sodium chloride | 8% |
| | | formaldehyde | 50 ppm |
| | | water | 66% |

TABLE 5
LiBr crystallization temperature depression comparison of 2-
phosphonoacetic acid (1) and its cesium salts

| | | | Crystal- | Crystallization |
|---|---|---|---|---|
| | | | lization | Temp |
| | | [Additive] | Temperature | Depression |
| Additive | LiBr wt % | (ppm) | (° C.) | (° C.) |
| 2-phosphonoacetic | 65.5% | 1083 | 47 | −3.5 |
| acid | 65.5% | 10949 | 44 | −0.5 |
| cesium | 65.5% | 1054 | 45 | 0 |
| phosphonoacetate | 65.5% | 10141 | 39 | 5 |
| tricesium | 65.5% | 1042 | 44 | 1 |
| phosphonoacetate | 65.5% | 10054 | 38 | 7 |

TABLE 6
LiBr crystallization temperature depression comparison of
ethylenediaminetetramethylphosphonic acid (2) and its cesium salt

| | | | | Crystallization |
|---|---|---|---|---|
| | | | Crystallization | Temp |
| | | [Additive] | Temperature | Depression |
| Additive | LiBr wt % | (ppm) | (° C.) | (° C.) |
| ethylenediaminetetramethyl- | 65.5% | 1064 | 48 | −4.5 |
| phosphonic acid | 65.5% | 11159 | 37 | 6.5 |
| cesium edta-phosphonate | 65.5% | 991 | 33 | 11 |
| | 65.5% | 9964 | 28 | 16 |

TABLE 7
LiBr crystallization temperature depression comparison of
etidronic acid (3) and its sodium salts

| | | | Crystal- | Crystallization |
|---|---|---|---|---|
| | | | lization | Temp |
| | | [Additive] | Temperature | Depression |
| Additive | LiBr wt % | (ppm) | (° C.) | (° C.) |
| etidronic acid | 65.5% | 987 | 46 | −1 |
| | 65.5% | 9546 | 44 | 1 |
| sodium etidronate | 65.5% | 1165 | 46 | −0.5 |
| | 65.5% | 10166 | 41 | 4.5 |
| tetrasodium | 65.5% | 1082 | 41 | 4 |
| etidronate | 65.5% | 10018 | 29 | 16 |

TABLE 8
LiBr crystallization temperature depression comparison of
etidronic acid (3) and its cesium salts

| | | | Crystal- | Crystallization |
|---|---|---|---|---|
| | | | lization | Temp |
| | | [Additive] | Temperature | Depression |
| Additive | LiBr wt % | (ppm) | (° C.) | (° C.) |
| etidronic acid | 65.5% | 987 | 46 | −1 |
| | 65.5% | 9546 | 44 | 1 |
| cesium etidronate | 65.5% | 1116 | 47 | 0 |
| | 65.5% | 10007 | 35 | 10 |
| tetracesium | 65.5% | 1081 | 42 | 3.5 |
| etidronate | 65.5% | 10187 | 44 | 1.5 |

TABLE 9
LiBr crystallization temperature depression comparison of
phosphonomethyliminodiacetic acid (4) and its cesium salt

| | | | Crystal- | Crystal- |
|---|---|---|---|---|
| | | | lization | lization |
| | | | Temper- | Temp |
| | | [Additive] | ature | Depression |
| Additive | LiBr wt % | (ppm) | (° C.) | (° C.) |
| phosphonomethylimino- | 65.5% | 1161 | 46 | -2.5 |
| diacetic acid | 65.5% | 10362 | 43 | 0.5 |
| cesium | 65.5% | 1087 | 45 | 0 |
| phosphonodiacetate | 65.5% | 10190 | 34 | 10 |

TABLE 10
LiBr crystallization temperature depression of Dequest 2066
(diethylene-triaminepenta (methylenephosphonic acid) sodium salt) (5)

| | | | Crystal- | Crystal- |
|---|---|---|---|---|
| | | | lization | lization |
| | | | Temper- | Temp |
| | | [Additive] | ature | Depression |
| Additive | LiBr wt % | (ppm) | (° C.) | (° C.) |
| diethylenetriaminepenta | 65.5% | 1121.92 | 46 | 0 |
| (methylenephosphonic | 65.5% | 11020.60 | 20 | 25 |
| acid) sodium salt | | | | |

Additives, such as lubricants, corrosion inhibitors, stabilizers, dyes, and other appropriate materials may be added to form or enhance working fluids, i.e. refrigerant pair compositions, useful for the invention for a variety of purposes provided they do not have an undesirable influence on the extent to which the refrigerant is absorbed by the absorbent. Working fluids as used in this invention may be prepared by any convenient method, including mixing or combining the desired amounts of each component in an appropriate container using, for example, known types of stirrers having rotating mixing elements.

This invention also provides devices utilizing absorption cycles of the invention. Devices of the invention include, but are not limited to, refrigerators, car air conditioners, residential air conditioners, commercial air conditioners, transport air conditioners, commercial ice machines, transport ice machines, and industrial cooling systems.

Refrigerants and absorbents, and methods of use thereof, suitable for use in this invention are also described in U.S. Patent Publication Nos. 2006/0197053, 2007/0144186 and 2007/0019708, each of which is by this reference incorporated in its entirety as a part hereof for all purposes

In addition to the vendors named elsewhere herein, various materials suitable for use herein may be made by processes known in the art, or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Other related absorption temperature adjustment systems, and methods for using same, are disclosed in the concurrently-filed, commonly-assigned applications listed as follows by attorney docket number and U.S. Provisional filing number, each of which is by this reference incorporated in its entirety as a part hereof for all purposes, to-wit:
FL1463, U.S. Provisional Application No. 61/165,160 (now U.S. Application Ser. No. 12/______);
FL1506, U.S. Provisional Application No. 61/165,166 (now U.S. Application Ser. No. 12/______); and
FL1507, U.S. Provisional Application No. 61/165,173 (now U.S. Application Ser. No. 12/______).

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

Each of the formulae shown herein describes each and all of the separate, individual compounds that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, or plurality of compounds, may in such event be characterized by a definition of one or more of the variable radicals, substituents or numerical coefficents that refers to the whole group of the prescribed range for that variable but where the member(s) omitted to form the subgroup are absent from the whole group.

What is claimed is:

1. A temperature adjustment device that executes an absorption cycle, wherein the working fluid in the device comprises an aqueous solution of a lithium halide and an ionic compound; wherein, in the ionic compound, the cations are selected from the group consisting of lithium, sodium, potassium, rubidium, cesium and mixtures thereof; and the anion is selected from among the members of the following groups:
(a) the group consisting of carborates (1-carbadodecaborate(1-), optionally substituted with alkyl or substituted alkyl; carboranes (dicarbadodecaborate(1-) optionally substituted with alkylamine, substituted alkylamine, alkyl or substituted alkyl; [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, and [(CF₃CFHCF₂SO₂)₂N]⁻;
(b) the group consisting of carbonate, glycolate, aminoacetate (glycine), ascorbate, benzoate, catecholate, citrate, dimethylphosphate, fumarate, gallate, glycolate, glyoxylate, iminodiacetate, isobutyrate, kojate (5-hydroxy-2-hydroxymethyl-4-pyrone ion), lactate, levulinate, oxalate, pivalate, propionate, pyruvate, salicylate, succinamate, succinate, tiglate (CH₃CH═C(CH₃)COO⁻), tetrafluoroborate, tetrafluoroethanesulfonate, and tropolonate (2-hydroxy-2,4,6-cycloheptatrien-1-one ion),
(c) the group consisting of anions formed from glycolic, oxalic, malonic, succinic, glutaric, adipic, or maleic acid;
(d) the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, SCN⁻, and BR¹R²R³R⁴, and BOR¹OR²OR³OR⁴; wherein R¹, R², R³, and R⁴ are each independently selected from the group consisting of:
(xiii) H
(xiv) halogen
(xv) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(xvi) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xvii) C₆ to C₂₀ unsubstituted aryl, or C₃ to C₂₅ unsubstituted heteroaryl having one to three heteroatoms independently selected from the group consisting of O, N, Si and 5, and
(xviii) C₆ to C₂₅ substituted aryl, or C₃ to C₂₅ substituted heteroaryl having one to three heteroatoms independently selected from the group consisting of O, N, Si and 5, and wherein said substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F I, OH, NH₂ and SH,
(8) OH,
(9) NH₂, and
(10) SH;
(vii) —(CH₂)ₙSi(CH₂)ₘCH₃, —(CH₂)ₙSi(CH₃)₃, —(CH₂)ₙOSi(CH₃)ₘ, where n is independently 1-4 and m is independently 0-4;
wherein optionally at least two of R¹, R², R³, R⁴, R⁵, R⁶, R⁷, R⁸, R⁹, and R¹⁰ can together form a cyclic or bicyclic alkanyl or alkenyl group.
(e) the group of anions consisting of those represented by the structure of the following formula: 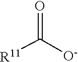
wherein R¹¹ is selected from the group consisting of:
(ix)-CH₃, —C₂H₅, or C₃ to C₁₀ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₁₀ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₁₀ unsubstituted aryl, or C₃ to C₁₀ unsubstituted heteroaryl having one to three heteroatoms independently selected from the group consisting of O, N, Si and 5, and
(xii) C₆ to C₁₀ substituted aryl, or C₃ to C₁₀ substituted heteroaryl having one to three heteroatoms independently selected from the group consisting of O, N, Si and 5, and wherein said substituted aryl or substituted heteroaryl has one to three substituents independently selected from the group consisting of:
(1) —CH₃, —C₂H₅, or C₃ to C₁₀ straight-chain, branched or cyclic alkane or alkene, optionally substituted with at least one member selected from the group consisting of Cl, Br, F I, OH, NH₂ and SH,
(8) OH,
(9) NH₂, and
(10) SH; and
(f) the member of the group consisting of the anion represented by the structure of the following formula 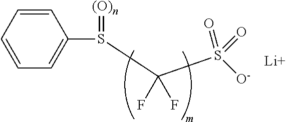
wherein n=0-2 and m=1-2,

2. An aqueous solution of a lithium halide and an ionic compound as described in claim 1.

3. A method of adjusting the temperature of an object, medium or a space comprising executing an absorption cycle in a device located adjacent to the object, medium or space, wherein water is absorbed into an aqueous solution of a lithium halide and an ionic compound as described in claim 1.

4. In an aqueous solution of a lithium halide, a method of decreasing either or both of the temperature at which the onset of crystallization in the solution occurs, or the temperature at which the solution freezes, comprising admixing with the solution an additive comprising an ionic compound as described in claim 1.
